(19) United States
(12) Patent Application Publication
(10) Pub. No.: US 2016/0160901 A1
(43) Pub. Date: Jun. 9, 2016

(54) TUBE WELD

(71) Applicant: PW Power Systems, Inc., Glastonbury, CT (US)

(72) Inventors: Ralph David Turley, Durham, CT (US); Anthony Patrick Maiorana, Old Saybrook, CT (US)

(21) Appl. No.: 14/559,158

(22) Filed: Dec. 3, 2014

(51) Int. Cl. F16B 17/00; B23K 31/02; F16M 5/00

(52) U.S. Cl. CPC F16B 17/004; F16M 5/00; B23K 31/02

(57) ABSTRACT

A joint weld between a rod and a hollow tube is disclosed. The rod has a cylindrical first end, and the hollow tube has a second end situated coaxially about a first axial length of the cylindrical first end. A plurality of circumferentially distributed scallops in the second end extend axially to at most a second axial length less than the first axial length to form an end pattern with varying axial extent as a function of circumferential position. The joint includes a weld along a perimeter of the end pattern, between the hollow tube and the rod.

### BACKGROUND

The present invention relates generally to joint welding, and more particularly to a tube joint structure and weld pattern with increased weld area and strength.

Welds are commonly used to join metallic structures. The strength of a weld joint is ordinarily a function of weld area and the materials used. In many applications, weld joints are the weakest parts of a structure. Support structures, for example, are typically designed for particular load requirements, and are often formed at least in part from rigid metallic posts, rods, and/or tubes joined together at weld joints. Although load requirements can place demands on all components of a support structure (e.g. weight support, vibration tolerance, stress tolerance, etc.), weld strength in particular is often the critical factor in determining the overall strength and integrity of a structure. Where load requirements demand higher overall structural strength, weld joints may need to be strengthened. Because welding is only possible at the interface of joined components, strengthening a weld by adding more depth of weld material has sharply diminishing returns. A degree of improvement to weld strength is often possible by using advanced materials, at additional cost.

### SUMMARY

In one embodiment, the present invention is directed toward a joint weld comprising a rod and a hollow tube. The rod has a cylindrical first end, and the hollow tube has a second end situated coaxially about a first axial length of the cylindrical first end. A plurality of circumferentially distributed scallops in the second end extend axially to at most a second axial length less than the first axial length to form an end pattern with varying axial extent as a function of circumferential position. The joint includes a weld along a perimeter of the end pattern, between the hollow tube and the rod.

In another embodiment, the present invention is directed toward a support strut comprising a welded-together strut head and strut body. The strut head has a cylindrical section with a rod radius. The strut body has a tubular portion with an inner radius slightly greater than the rod radius, in an assembled state. The tubular portion has a plurality of axially extending, circumferentially distributed scallops that define an end pattern with varying axial extent as a function of circumferential position. The weld between the strut head and body follows the end pattern.

In still another embodiment, the present invention is directed toward a method for joining a rod to a hollow tube. First, a plurality of circumferentially distributed, axially extending scallops are formed at an end of the hollow tube. A first length of the rod is inserted coaxially into the first end of the hollow tube, and the rod is welded to the hollow tube along a perimeter of the end of the hollow tube.

### BRIEF DESCRIPTION OF THE DRAWINGS

FIG. 1 is a simplified perspective view of an engine with cylindrical support struts.

FIG. 2a is a perspective view of one end of a cylindrical support strut of FIG. 1.

FIG. 2b is an exploded view of the cylindrical support strut of FIG. 2.

FIG. 3 is a flat pattern schematic view of a prior art tube pattern for a cylindrical support strut.

FIGS. 4 and 5 are flat pattern schematic views of tube patterns for the cylindrical support strut of FIGS. 2a and 2b.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

Embodiments of the present invention relate to a weld joint wherein a tubular section surrounds and is welded to a coaxially inner tube or cylinder. The tubular section has an end pattern with scallops and/or crenellations that lengthen the perimeter of the tubular section, and correspondingly increase the weld area available at the interface of the tubular section and the tube or cylinder.

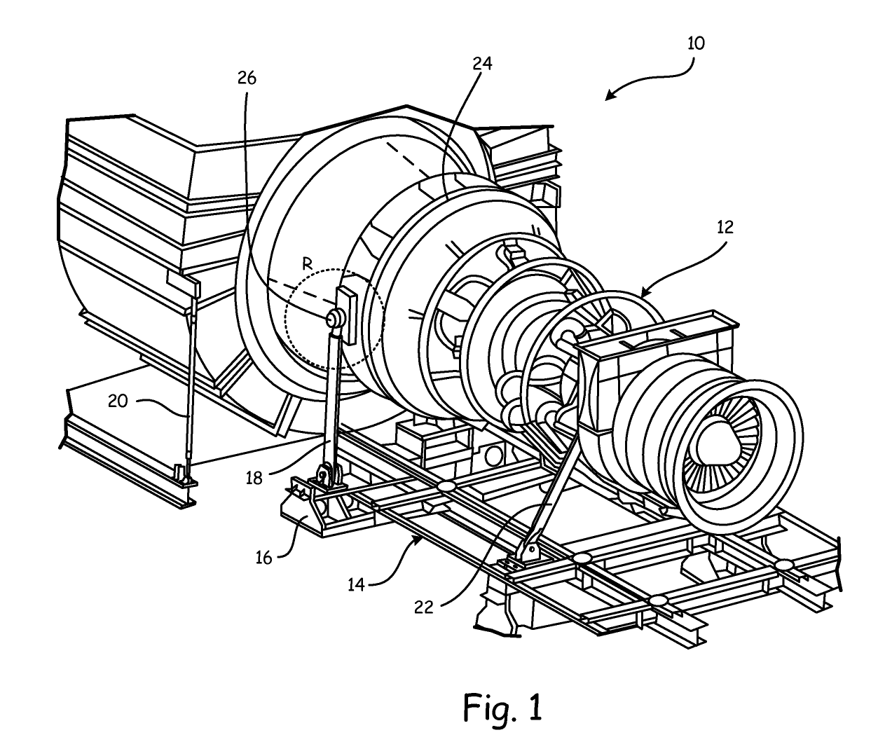

FIG. 1 is a simplified perspective view of engine installation 10, with gas turbine engine 12 and support structure 14. Support structure 14 includes support frame 16 and support struts 18, 20, and 22. Gas turbine engine 12 includes casing 24 with trunnions 26. Gas turbine engine 12 can, for example, be an industrial power turbine. Gas turbine engine 12 serves as one example of a heavy structure anchored and supported by support structure 14. In the illustrated embodiment, casing 24 serves as an outer structural wall of gas turbine engine 12, and includes a plurality of trunnions 26 that connect to at least support struts 18. More generally, the weld joint of disclosed embodiments can be used in a wide range of applications for support structures of other types, including any kind of heavy industrial assembly.

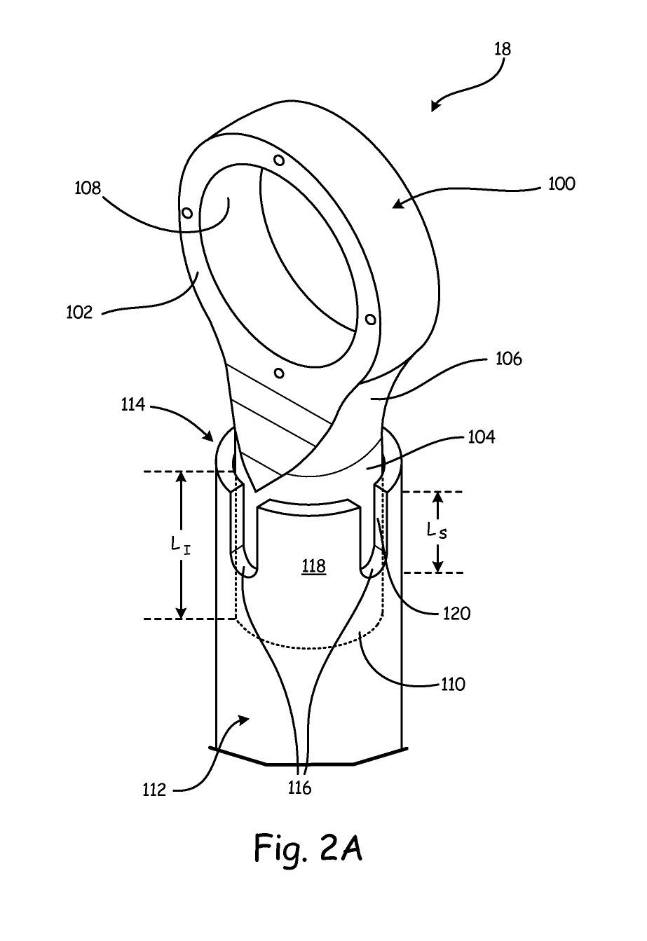

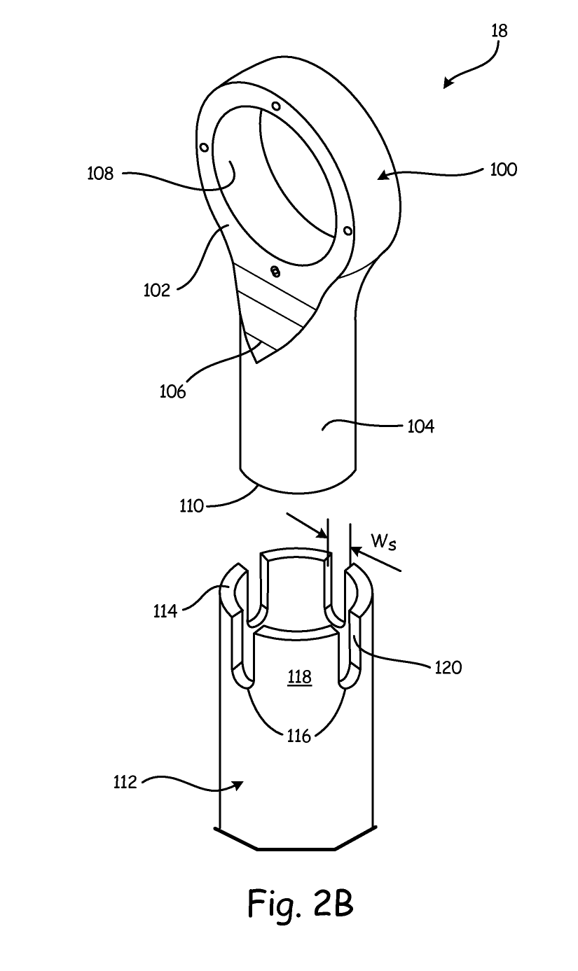

Support frame 16 is a bracing and/or mounting assembly such as a permanent installation frame or a transportation frame for gas turbine engine 12. Support structure 14 supports gas turbine engine 12 via a plurality of structural connections through support struts 18, 20, and 22. Support struts 18, 20, and 22 can, for example, be rods, tubes, and/or posts attached to support frame 16 and casing 24 of gas turbine engine 12 via fixed or flexible joints. In the illustrated embodiment, support strut 18 is formed of at least two pieces joined by a weld, as described in greater detail below with respect to FIGS. 2a and 2b.

FIGS. 2a and 2b are unexploded and exploded perspective views, respectively, of a portion of support strut 18 situated within region R of FIG. 1. Support strut 18 is formed of at least two pieces: strut head 100 (with attachment section 102, cylindrical section 104, intermediate section 106, ball bushing 108, and rod end 110), and strut body 112 (with tubular region 114, scallops 116, crenellations 118, and tube edge 120). These two pieces are welded together as described in greater detail with respect to FIGS. 4 and 5.

In the illustrated embodiment, support strut 18 is an elongated support member configured to mate with trunnion 26, thereby securing support strut 18 to casing 24. More generally, however, embodiments of the disclosure can be used with any strut or element with a tubular section joined to a radially inner tube or cylinder by a weld.

As shown in FIGS. 2a and 2b, strut head 100 is a rigid, solid body of machined and/or cast metal. Attachment section 102 is a flattened or spaded section of strut head 100 that can, for example, include ball bushing 108 to interface with trunnion 26. Attachment section 102 broadens through a tapered intermediate section 106 to cylindrical section 104. Cylindrical section 104 may be a tube or rod extending an axial distance from intermediate section 106 to rod end 110. Although described hereinafter primarily as a solid rod, cylindrical section 104 can in some embodiments be hollow. FIG. 2a illustrates cylindrical section 104 and rod end 110 in phantom within strut body 112, while FIG. 2b provides an exploded view illustrating cylindrical section 104 and rod end 110 separated from strut body 112.

Strut body 112 is a post or tube having at least a tubular or hollow length at tubular region 114 configured to surround cylindrical section 104. In some embodiments strut body 112 can be a metallic tube or cylinder. In other embodiments, strut body 112 can be a solid rod that is hollow only in tubular region 114. Tubular region 114 is an axially terminal region of strut body 112 configured to mate with cylindrical section 104 of strut head 100. The terminal axial extent of tubular region 114 is defined by tube edge 120. In the depicted embodiment, tubular region 114 has an end pattern comprising a plurality of scallops 116 extending a scallop length L_{S} (see FIG. 2a) in an axial direction. This end pattern includes, and is defined by, the contour of tube edge 120. In the illustrated embodiment, scallops 116 have scallop width W_{S} (see FIG. 2b), and form a plurality of crenellations 118 in tubular region 114. In alternative embodiments, scallops 116 can define an arced or sinusoidal end pattern as illustrated in FIG. 5, and described below. Regardless of embodiment, the end pattern created by scallops 116 produces a varying axial extent of tube edge 120 as a function of circumferential position about tubular region 114. In some embodiments scallops 116 can be cast directly into strut body 112. In other embodiments, scallops 116 can be subtractively machined from the tubular region 114 of strut body 112.

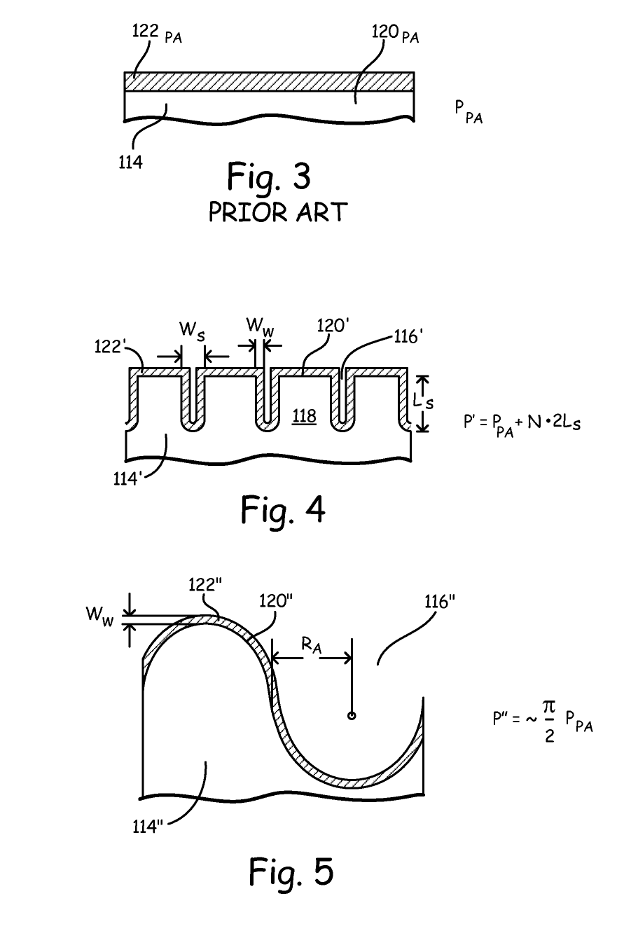

Support strut 18 is formed by joining strut head 100 to strut body 112. Cylindrical section 104 of strut head 100 has a radius close to but less than an inner radius of strut body 112 in tubular region 114, during installation. In some cases, however, tubular region 114 can have an inner radius less than or equal to the radius of cylindrical section 104 at a normal operating temperature. In such cases, in order to provide an interference fit, strut body 112 is heated to provide sufficient thermal expansion to allow cylindrical section 104 to fit within strut body 112 during installation. After installation, in either embodiment, the radius of cylindrical section 104 and the inner radius of tubular region 114 are both approximately equal to a weld radius R_{W}, discussed hereinafter with respect to FIGS. 3, 4, and 5. Although the embodiments are described primarily as relating to cylindrical or tubular structures, the present weld joint may be used with any telescopic connection secured via an additive weld, including connections between pieces with polygonal cross-sections.

During assembly, an installation length L_{I} of cylindrical section 104 is inserted within strut body 112. Strut head 100 is then joined to strut body 112 via a weld along a perimeter of tubular region 114, and following the end pattern of tube edge 120 created by scallops 116, as described below with respect to FIGS. 4 and 5. Installation length L_{I} and scallop length L_{S} are selected such that L_{I}>L_{S}, so that the entirety of the perimeter of tubular region 114 acts as a functional weld length of this joint.

FIGS. 3, 4, and 5 are flat pattern schematic views of tubular region patterns with welds 122_{PA}, 122′, and 122″, respectively, deposited at the interface of strut body 112 and cylindrical section 104. FIG. 3 depicts a prior art pattern for a cylindrical strut with tube edge 120_{PA} having no scallops 116, and correspondingly an uncontoured (flat) end pattern with a perimeter P_{PA}=2πR_{W} followed by weld 122_{PA}. FIGS. 4 and 5 depict end patterns with scallops 116′ and 116″ according to the embodiments of the disclosure, resulting in increased perimeters P′ and P″, respectively. FIG. 4 illustrates tubular region 114′ with tube edge 120′ defined (at least in part) by scallops 116′, with weld 122′. FIG. 5 illustrates tubular region 114″ with tube edge 120″ defined by scallops 116″, with weld 122″. Welds 122′ and 122″ have weld width W_{W}.

FIG. 4 depicts an end pattern as described and depicted above with respect to FIGS. 2a and 2b. Strut body 112 is marked within tubular region 114′ by a plurality of groove-or slot-like scallops 116′ forming crenellations 118. Each scallop 116′ has circumferential width W_{S} and axial length L_{S}. The resulting perimeter P′ of tube edge 120′ has length P′≈P_{PA}+N*2L_{S}, where N is the number of scallops 116′ in the pattern (4, in the illustrated embodiment). The total weld area produced by the end pattern of FIG. 4 is approximately W_{W}* P′≈W_{W}*(2πR_{W}+2N*L_{S}), where R represents a radius at the axial origination of the scallop 116′ (assuming W_{W}<<P′ and moderate N); that is, the weld width multiplied by the perimeter length produced by the introduction of scallops 116′. This increase in weld area over prior art uncontoured designs results in greater weld strength at the joint of strut head 100 and strut body 112. In at least some embodiments, scallop width W_{S} is selected such that W_{S}≧2W_{W}, providing space for two full welds within each scallop 116′. This avoids weld overlap that would reduce total weld area. In the depicted embodiment, tube edge 120′ has four scallops 116′ defining four crenellations 118. The overall weld area provided by the present invention can, in this embodiment, be increased by adding additional scallops 116 (i.e. increasing N), or by increasing the axial length of at least some of the scallops (i.e. increasing L_{S}) up to L_{I}. In some embodiments, for example, total perimeter P′ can be at least 1.5 times P_{PA}.

FIG. 5 depicts an end pattern with an arced end pattern wherein scallops 116″ are defined by arc radius R_{A}, with a maximum axial length of 2R_{A}. Scallops 116″ define perimeter P″ of tube edge 120″ with total length P″=½πP_{PA}=π²R_{W}, regardless of arc radius R_{A} or the number of scallops N. The resulting total weld area produced by the end pattern of FIG. 5 is approximately W_{W}*P″≈W_{W}π²R_{W} (assuming W_{W}<<P′ and moderate N). In alternative embodiments, scallops 116″ can define a tube edge 120″ having a sinusoidal contour.

FIGS. 4 and 5 illustrate two possible embodiments of the present disclosure, wherein an end pattern of tubular region 114 of strut body 112 has scallops and/or crenellations that lengthen the perimeter of the tubular section, and correspondingly increase the weld area available at the interface of the tubular section and the cylindrical section of the strut head. This increase in weld area provides a stronger weld joint for a given strength of weld material, thereby reducing a need to consider expensive materials or additional connections for a desired weld joint strength.

### Discussion of Possible Embodiments

The following are non-exclusive descriptions of possible embodiments of the present invention.

A weld joint comprising: a rod with a cylindrical first end; a hollow tube with a second end situated coaxially about a first axial length of the cylindrical first end; a plurality of circumferentially distributed scallops in the second end, extending axially to at most a second axial length less than the first axial length to form an end pattern with varying axial extent as a function of circumferential position; and a weld along the perimeter of the end pattern between the hollow tube and the rod.

The weld joint of the preceding paragraph can optionally include, additionally and/or alternatively, any one or more of the following features, configurations and/or additional components:

A further embodiment of the foregoing weld joint, wherein the end pattern is a crenellated pattern, and the circumferentially distributed scallops are axially-extending slots. A further embodiment of the foregoing weld joint, wherein the crenellated pattern includes at least four grooves defining four crenellations.

A further embodiment of the foregoing weld joint, wherein the weld has a weld width, and each of the axially-extending slots has a circumferential slot width at least twice the weld width.

A further embodiment of the foregoing weld joint, wherein the end pattern is an arced pattern or sinusoidal pattern.

A further embodiment of the foregoing weld joint, wherein the weld has a weld length at least 1.5 times a circumference of the hollow tube.

A support strut comprising: a strut head with a cylindrical section having a rod radius; a strut body with a tubular portion with an inner radius slightly greater than the rod radius in an assembled state, the tubular portion having a plurality of axially extending, circumferentially distributed scallops that define an end pattern with varying axial extent as a function of circumferential position; a weld between the strut head and the strut body, following the end pattern of the strut body.

The support strut of the preceding paragraph can optionally include, additionally and/or alternatively, any one or more of the following features, configurations and/or additional components:

A further embodiment of the foregoing support strut, wherein the strut head includes an attachment section configured to allow connection to an adjacent piece.

A further embodiment of the foregoing support strut, wherein the strut head further comprises a ball bushing.

A further embodiment of the foregoing support strut, wherein the strut head tapers from the cylindrical section to the attachment section.

A further embodiment of the foregoing support strut, wherein end pattern is a crenellated pattern

A further embodiment of the foregoing support strut, wherein the strut body is a hollow cylindrical tube.

A further embodiment of the foregoing support strut, wherein the circumferentially distributed scallops have at most a first axial length, and further wherein the strut head extends into the strut body a second axial length greater than the first axial length.

A method for joining a rod to a hollow tube, the method comprising: forming a plurality of circumferentially distributed, axially extending scallops at an end of the hollow tube; inserting a first length of the rod coaxially into the first end of the hollow tube; welding the rod to the hollow tube along a perimeter of the end of the hollow tube.

The method of the preceding paragraph can optionally include, additionally and/or alternatively, any one or more of the following features, configurations and/or additional components:

A further embodiment of the foregoing method, wherein each of the plurality of circumferentially distributed scallops has at most a second axial length less than the first axial length.

A further embodiment of the foregoing method, wherein forming the scallops comprises forming axially-extending grooves that define crenellations in the first end of the hollow tube.

A further embodiment of the foregoing method, wherein welding the tube comprises depositing a weld with a thickness no greater than half a width of the grooves.

A further embodiment of the foregoing method, wherein forming the scallops comprises forming an arced pattern or sinusoidal pattern at the first end of the hollow tube.

A further embodiment of the foregoing method, wherein forming the plurality of scallops comprises machining away material from the hollow tube.

A further embodiment of the foregoing method, wherein forming the plurality of scallops comprises casting the hollow tube with a scalloped contour at the end of the hollow tube.

### Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A weld joint comprising:
a rod with a cylindrical first end;
a hollow tube with a second end situated coaxially about a first axial length of the cylindrical first end;
a plurality of circumferentially distributed scallops in the second end, extending axially to at most a second axial length less than the first axial length to form an end pattern with varying axial extent as a function of circumferential position; and
a weld along the perimeter of the end pattern between the hollow tube and the rod.

2. The weld joint of claim 1, wherein the end pattern is a crenellated pattern, and the circumferentially distributed scallops are axially-extending slots.

3. The weld joint of claim 2, wherein the crenellated pattern includes at least four grooves defining four crenellations.

4. The weld joint of claim 2, wherein the weld has a weld width, and each of the axially-extending slots has a circumferential slot width at least twice the weld width.

5. The weld joint of claim 1, wherein the end pattern is an arced pattern or sinusoidal pattern.

6. The weld joint of claim 1, wherein the weld has a weld length at least 1.5 times a circumference of the hollow tube.

7. A support strut comprising:
a strut head with a cylindrical section having a rod radius;
a strut body with a tubular portion with an inner radius slightly greater than the rod radius in an assembled state, the tubular portion having a plurality of axially extending, circumferentially distributed scallops that define an end pattern with varying axial extent as a function of circumferential position;
a weld between the strut head and the strut body, following the end pattern of the strut body.

8. The strut support of claim 7, wherein the strut head includes an attachment section configured to allow connection to an adjacent piece.

9. The strut support of claim 8, wherein the strut head further comprises a ball bushing.

10. The strut support of claim 7, wherein the strut head tapers from the cylindrical section to the attachment section.

11. The strut support of claim 7, wherein the end pattern is a crenellated pattern.

12. The strut support of claim 7, wherein the strut body is a hollow cylindrical tube.

13. The strut support of claim 7, wherein the circumferentially distributed scallops have at most a first axial length, and further wherein the strut head extends into the strut body a second axial length greater than the first axial length.

14. A method for joining a rod to a hollow tube, the method comprising:
forming a plurality of circumferentially distributed, axially extending scallops at an end of the hollow tube;
inserting a first length of the rod coaxially into the first end of the hollow tube;
welding the rod to the hollow tube along a perimeter of the end of the hollow tube.

15. The method of claim 14, wherein each of the plurality of circumferentially distributed scallops has at most a second axial length less than the first axial length.

16. The method of claim 14, wherein forming the scallops comprises forming axially-extending grooves that define crenellations in the first end of the hollow tube.

17. The method of claim 16, wherein welding the tube comprises depositing a weld with a thickness no greater than half a width of the grooves.

18. The method of claim 14, wherein forming the scallops comprises forming an arced pattern or sinusoidal pattern at the first end of the hollow tube.

19. The method of claim 14, wherein forming the plurality of scallops comprises machining away material from the hollow tube.

20. The method of claim 14, wherein forming the plurality of scallops comprises casting the hollow tube with a scalloped contour at the end of the hollow tube.
